(19) United States
(12) Patent Application Publication
(10) Pub. No.: US 2024/0083358 A1
(43) Pub. Date: Mar. 14, 2024

(54) AUTOMATIC MIRROR ADJUSTMENT SYSTEM AND METHOD

(71) Applicant: VINAI ARTIFICIAL INTELLIGENCE APPLICATION AND RESEARCH JOINT STOCK COMPANY, Ha Noi (VN)

(72) Inventors: Ngoc Ba Son NINH, Ha Noi (VN); Quang Tu TA, Ha Noi (VN); Viet Tien TRAN, Ha Noi (VN); Hai Hung BUI, Ha Noi (VN); Thi Ngoc Lan LE, Ha Noi (VN); Duc Toan BUI, Ha Noi (VN); Thanh Vuong CAP, Ha Noi (VN); Huu Tuyen NGUYEN, Ha Noi (VN)

(21) Appl. No.: 18/504,428

(22) Filed: Nov. 8, 2023

Related U.S. Application Data
(63) Continuation of application No. PCT/IB2022/058603, filed on Sep. 13, 2022.

(51) Int. Cl. B60R 1/072; G06T 7/73

(52) U.S. Cl. CPC B60R 1/072; G06T 7/73; G06T 2207/30201; G06T 2207/30268; H04N 23/90

(57) ABSTRACT

A method for adjusting a side mirror of a vehicle includes capturing, by a primary camera provided in front of a driver of the vehicle, a facial image of the driver; estimating a 3D eye location with respect to a 3D coordinate of the primary camera based on the captured facial image; mapping the estimated 3D eye location to a respective set of pitch and yaw angles of the side mirror based on a lookup table; and rotating the side mirror to a target position in accordance with the respective set of pitch and yaw angles. The lookup table includes a plurality of rows, each row containing a pair of a key and a set of values. The key is a 3D eye location, and the set of values includes a set of pitch and yaw angles of the side mirror corresponding to the 3D eye location.

### CROSS-REFERENCE TO RELATED APPLICATION

This application is a Continuation of PCT/IB2022/058603 filed Sep. 13, 2022, which is incorporated herein by reference in its entirety.

### TECHNICAL FIELD

The present invention relates generally to motor vehicles. More particularly, the present invention relates to an automatic mirror adjustment system and method for vehicles.

### RELATED ART

Mirrors are commonly known to be implemented in vehicles to provide a driver of the vehicle with a field of view of the environment surrounding the vehicle, typically the rearview and/or the side view of the vehicle. Thereby, for example, when the driver attempts to park the vehicle in a space behind thereof, the side-view/rear-view mirrors can provide the driver with visual information regarding such space so that the driver can maneuver the vehicle to the desired location for parking only by looking at the side mirror and without having to turn the head to look behind. Moreover, when the driver is driving or attempts to change lanes when driving, the side mirror provides the driver with information regarding the lanes behind and partially beside to the vehicle. Such information is extremely important for the driver as the driver is participating in the traffic. In order to fully and accurately provide the driver with the information of the environment beside or behind the vehicle, the mirror is required to be in its optimal position, that is, the position in which the alignment of the mirror with respect to the seating position, height and distance to the side mirror of the driver is considered correct, in other words, the field of view of the rear/side of the vehicle provided by the mirror to the driver is optimal.

In order to achieve this optimal position of the mirror, generally, the driver has to manually adjust the mirror either by the direct force applied to the mirror or by a mirror adjustment system implemented in the vehicle. This operation of manually adjusting the mirror may be bothersome for some drivers as the driver has to adjust the mirror constantly during driving due to the changes in their driving position, especially on a long road trip. Furthermore, there is a tendency that the manual adjustment of the mirror from the driver cannot achieve the optimal field of view for the driver since such adjustment is subjective and merely based on the sensation and comfort of the driver. As a result, the manual adjustment of the mirror from the driver may lead to the optimal field of view cannot be achieved, thus various blind spots in the field of view provided by the mirror may not be seen, and this may cause danger to the driver since the driver is not aware of the potential risks such as other vehicles, pedestrian or other objects present in those blind spots, leading to accidents or collisions.

There have been known systems and methods of automatically adjusting the side mirror of the vehicle in order to deal with the aforementioned underlying problems of the manual adjustment of the side mirror. Some of these systems and methods use the driver's physical height or prior knowledge of the driver to calculate an optimal rotation angle at which a mirror is to be rotated, which sometimes may cause significant errors in the adjustment of the side mirror due to the inconsistent relationship between the height and the location of the eye of the driver, or inconsistency in physical characteristics between various drivers. Some others require some assumptions about the driver and the vehicle's interior to estimate the location of the driver's eye. In the actual varied physical environment (in terms of light condition, vehicle model, etc.), those assumptions cause significant errors resulting in bad performance of automatically adjustment of the side mirror. Yet other known systems and methods may require a 3D model of each mirror and geometric relation between the vehicle, cameras included in the systems, and the side mirror, which may be complicated in calibration.

From all of the above, it is desirable to provide a system and method of automatically adjusting the side mirror of the vehicle that is capable of automatically adjusting the side mirror of the vehicle to optimal rotation angles, thereby providing the driver with an optimal field of view in a much more precise and simpler manner, without encountering errors or having to deal with the above-mentioned complicated calibration steps.

### SUMMARY

The invention has been made to solve the above-mentioned problems, and an object of the invention is to provide a system and method of automatically adjusting one or more mirrors of a vehicle to their optimal rotation angle, thereby providing a driver with an optimal field of view of the side-view and/or the rear-view of the vehicle in an automatic manner in which the driver does not have to manually adjust the side mirror by themselves which may cause significant errors in terms of viewing angle, helps the driver with precisely maneuvering the vehicle in changing lanes, parking or the like, thus provide a more convenient, better and safer driving experience for the driver.

Problems to be solved in embodiments of the invention are not limited thereto and include the following technical solutions and also objectives or effects understandable from the embodiments.

According to an embodiment of the invention, there is provided an automatic mirror adjustment system for a vehicle, the system comprises:
a primary camera provided in front of a driver of the vehicle, wherein the primary camera is configured to capture a facial image of the driver;
a side mirror disposed on an exterior side of the vehicle and being adjustable for rearview visibility of the vehicle;
an artificial intelligence (AI) model configured to estimate a three dimension (3D) eye location with respect to the 3D coordinate of the primary camera based on the captured facial image;
a mapping module comprising a lookup table for mapping the estimated 3D eye location to a respective set of pitch and yaw of the side mirror, wherein the lookup table comprises a plurality of rows, each row contains a pair of a key and a set of values, and wherein the key is a 3D eye location and the set of values is a set of pitch and yaw of the side mirror corresponding to the 3D eye location; and
a mirror control module configured to rotate the side mirror to a target position in accordance with the respective set of pitch and yaw;
wherein the system is configured to build the lookup table using operations of:
providing a secondary camera at a rear handle of the vehicle so that the secondary camera faces the side mirror;
providing a target calibration pattern at the seat of the driver for simulating the eye of the driver so that the target calibration pattern can be captured by the secondary camera via the side mirror;
moving the side mirror to a plurality of rotation angles corresponding to a plurality of sets of pitch and yaw;
for each set of pitch and yaw, moving the target calibration pattern to k positions such that images of the target calibration pattern captured by the secondary camera stays within a predetermined region on the side mirror;
recording 3D locations of k positions with respect to the 3D coordinate of the primary camera as keys; and
pairing the keys with the each set of pitch and yaw to generate the plurality of rows of the lookup table.

According to another embodiment of the invention, there is provided an automatic mirror adjustment method for a vehicle, the method comprises:
capturing, by a primary camera provided in front of a driver of the vehicle, a facial image of the driver;
providing a side mirror on an exterior side of the vehicle, the side mirror is adjustable for rearview visibility of the vehicle;
estimating, by an artificial intelligence (AI) model, a three dimension (3D) eye location with respect to the 3D coordinate of the primary camera based on the captured facial image;
mapping, by a mapping module comprising a lookup table, the estimated 3D eye location to a respective set of pitch and yaw of the side mirror, wherein the lookup table comprises a plurality of rows, each row contains a pair of a key and a set of values, and wherein the key is a 3D eye location and the set of values is a set of pitch and yaw of the side mirror corresponding to the 3D eye location; and
rotating, by a mirror control module, the side mirror to a target position in accordance with the respective set of pitch and yaw;
wherein the method further comprises building the lookup table, the building comprises operations of:
providing a secondary camera at a rear handle of the vehicle so that the secondary camera faces the side mirror;
providing a target calibration pattern at the seat of the driver for simulating the eye of the driver so that the target calibration pattern can be captured by the secondary camera via the side mirror;
moving the side mirror to a plurality of rotation angles corresponding to a plurality of sets of pitch and yaw;
for each set of pitch and yaw, moving the target calibration pattern to k positions such that images of the target calibration pattern captured by the secondary camera stays within a predetermined region on the side mirror;
recording 3D locations of k positions with respect to the 3D coordinate of the primary camera as keys; and
pairing the keys with the each set of pitch and yaw to generate the plurality of rows of the lookup table.

According to another aspect of the invention, a method for adjusting a side mirror of a vehicle may include capturing, by a primary camera provided in front of a driver of the vehicle, a facial image of the driver; estimating a three dimensional (3D) eye location with respect to a 3D coordinate of the primary camera based on the captured facial image; mapping the estimated 3D eye location to a respective set of pitch and yaw angles of the side mirror based on a lookup table; and rotating the side mirror to a target position in accordance with the respective set of pitch and yaw angles. The lookup table may include a plurality of rows, each row containing a pair of a key and a set of values. The key may be a 3D eye location, and the set of values may include a set of pitch and yaw angles of the side mirror corresponding to the 3D eye location.

### BRIEF DESCRIPTION OF THE DRAWINGS

The above and other objects, features, and advantages of the invention will become more apparent to those of ordinary skill in the art by describing exemplary embodiments thereof in detail with reference to the accompanying drawings, in which:

FIG. 1 is a schematic view illustrating an exemplary automatic mirror adjustment system for a vehicle according to an embodiment of the invention;

FIG. 2A depicts a sub-system of the system of FIG. 1 for building a lookup table, according to the embodiment of the invention;

FIG. 2B depicts exemplary rows of the lookup table of FIG. 2A;

FIG. 2C depicts the steps of obtaining a plurality of rows of the lookup table of FIG. 2A;

FIG. 3 is a flow chart depicting an automatic mirror adjustment method for a vehicle according to an embodiment of the invention; and

FIG. 4 illustrates a process of building a lookup table used in the automatic mirror adjustment method of FIG. 3.

### DETAILED DESCRIPTION

While the invention may have various modifications and alternative forms, specific embodiments thereof are shown by way of example in the drawings and will be described herein in detail. However, there is no intent to limit the invention to the particular forms disclosed. On the contrary, the invention is to cover all modifications, equivalents, and alternatives falling within the spirit and scope of the appended claims.

It should be understood that, although the terms “first,” “second,” “primary,” “secondary,” and the like may be used herein to describe various elements, the elements are not limited by the terms. The terms are only used to distinguish one element from another element. For example, a first element could be termed a second element, and, similarly, a second element could be termed a first element without departing from the scope of the invention. As used herein, the term “and/or” includes any and all combinations of one or more of the associated listed items.

The terminology used herein is for the purpose of describing particular embodiments only and is not intended to be limiting to the invention. As used herein, the singular forms “a,” “an,” “another,” and “the” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

A vehicle as described in this disclosure may include, for example, a car or a motorcycle, or any suitable motorized vehicle, for example, the vehicle applied in maritime, workload handling machine, aviation, and space. Hereinafter, a car will be described as an example.

A vehicle as described in this disclosure may be powered by any suitable power source, and may be, for example, an internal combustion engine vehicle including an engine as a power source, a hybrid vehicle including both an engine and an electric motor as a power source, and/or an electric vehicle including an electric motor as a power source.

As used herein, an AI model is trained to output a predetermined output with respect to a predetermined input, and may include, for example, neural networks. A neural network refers to a recognition model that simulates a computation capability of a biological system using a large number of artificial neurons being connected to each other through edges.

The neural network uses artificial neurons configured by simplifying functions of biological neurons, and the artificial neurons may be connected to each other through edges having connection weights. The connection weights, parameters of the neural network, are predetermined values of the edges, and may also be referred to as connection strengths. The neural network may perform a cognitive function or a learning process of a human brain through the artificial neurons. The artificial neurons may also be referred to as nodes.

A neural network may include a plurality of layers. For example, the neural network may include an input layer, a hidden layer, and an output layer. The input layer may receive an input to be used to perform training and transmit the input to the hidden layer, and the output layer may generate an output of the neural network based on signals received from nodes of the hidden layer. The hidden layer may be disposed between the input layer and the output layer. The hidden layer may change training data received from the input layer to an easily predictable value. Nodes included in the input layer and the hidden layer may be connected to each other through edges having connection weights, and nodes included in the hidden layer and the output layer may also be connected to each other through edges having connection weights. The input layer, the hidden layer, and the output layer may respectively include a plurality of nodes.

Hereinafter, training a neural network refers to training parameters of the neural network. Further, a trained neural network refers to a neural network to which the trained parameters are applied.

Basically, the neural network may be trained through supervised learning or unsupervised learning. Supervised learning refers to a method of providing input data and label corresponding thereto to the neural network, while in unsupervised learning, the input data provided to the neural network does not contain label.

Hereinafter, embodiments will be described in detail with reference to the accompanying drawings, the same or corresponding components are denoted by the same reference numerals regardless of reference numbers, and thus the description thereof will not be repeated, wherein:

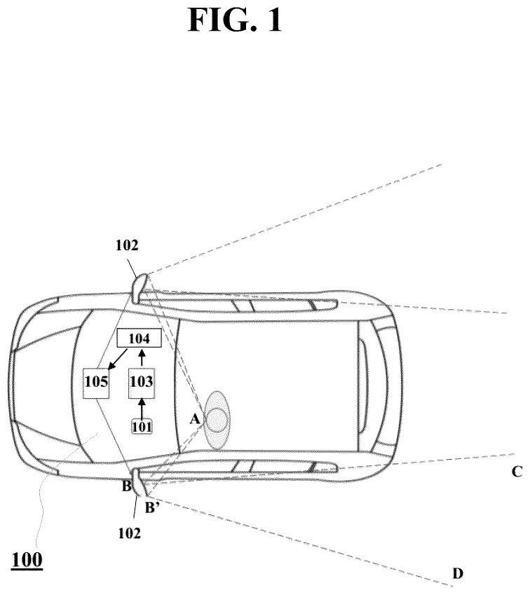

FIG. 1 is a schematic view illustrating an automatic mirror adjustment system for a vehicle according to an embodiment of the invention;

Referring to FIG. 1, an exemplary automatic mirror adjustment system 100 (hereinafter referred to as the system 100) implemented in a vehicle is depicted. Herein, the exemplary vehicle shown in FIG. 1 is a car, but other kinds of vehicle are possible. The system 100 comprises a primary camera 101 mounted in the vehicle and in front of the driver. The primary camera 101 may be pre-installed in the vehicle at the time of manufacturing, or may be a third-party camera that may be installed later in the vehicle and integrated with the system 100. The primary camera 101 may be electrically connected and communicate with other units of the system 100 via a data signal. The primary camera 101 may be a high resolution infrared camera, or a lower resolution camera, or even a RGB (Red Green Blue) camera. The primary camera 101 is configured to capture a facial image of the driver, and is able to send the data signal comprising the facial information of the driver based on the facial image to other units of the system 100 for processing. In an example, the primary camera 101 may capture a current facial image of the driver during the driving of the vehicle, for example, when the driver changes their driving position, then update the facial information of the driver to be included in the data signal based on the current facial image, and then send the updated data signal to other units of the system 100 in real-time.

The system 100 further comprises at least one side mirror 102. As shown in FIG. 1, the system 100 may comprise two side mirrors located on each of the left and right exterior sides of the vehicle. Each mirror provides the driver with a respective field of view of a partial surrounding area of the vehicle, in particular, a reflective field of view of the area behind (i.e., rearview visibility) and/or beside (i.e., sideview visibility) the vehicle. The side mirror 102 may be a plane mirror, a convex mirror or the like. The mirror side 102 is configured to be able to rotate/pivot around a rotation/pivot point such that it is possible to rotate the side mirror 102 to a position in accordance with a respective rotation angle. Each rotation angle of the side mirror 102 is defined by a respective set of pitch and yaw of the side mirror 102. Pitch represents a rotation degree around a horizontal axis of the rotation point of the mirror. Yaw represents a rotation degree around a vertical axis of the rotation point of the mirror.

The position of the side mirror 102 may be adjusted either by manual control by the driver or automatic control by the system 100, which will be described later. The manual control of the side mirror 102 may be realized, for example, by one or more buttons on the side panel located at a door of the vehicle, or one or more buttons on the center control panel, and/or on a touchscreen of an infotainment system of the vehicle, and/or one or more buttons on the steering wheel of the vehicle and/or the like. The driver may make use of the above described manual control to manually control the side mirror 102 or make further adjustments and/or fine-tune the position of the side mirror 102 after the automatic control of the side mirror 102 by the system 100, for example. The position of the side mirror 102 is adjusted such that the side mirror 102 is able to provide the driver with an optimal field of view of the rear and/or side areas on each side of the vehicle. That is, as illustrated in FIG. 1, from a seating position A in the vehicle of the driver, the driver is able to observe a rearview area BB ‘DC through the reflective images in the side mirror 102. According to an embodiment, the length of BB’ takes two-third (⅔) length of the side mirror 102.

The system 100 further comprises an artificial intelligence (AI) model 103. The AI model 103 is configured to estimate a three dimension (3D) eye location with respect to the 3D coordinate of the primary camera 101 based on the captured facial image obtained by the primary camera 101. In particular, the AI model 103 has been trained to extract facial information of the driver's face from the captured image and then use such facial information to estimate the 3D eye location. The facial information may comprise two-dimensional (2D) landmarks, the head pose of the driver (e.g., yaw, pitch, and roll angles of the driver's face), and other useful information, such as driver's eye gazes, driver's eye states (i.e., opened or closed state). In an example, in the eye location estimation step, the AI model 103 predicts 46 2D facial landmarks on the image plane. Then, the AI model 103 solves the PNP problem to find the transformation matrix from the driver's head to the primary camera 101. From that, the 3D eye location can be obtained.

The system 100 further comprises a mapping module 104 comprising a lookup table for mapping the estimated 3D eye location to an optimal rotation angle comprising a respective set of pitch and yaw of the side mirror 102. The lookup table comprises a plurality of rows, each row contains a pair of key and set of values, in which the key is a 3D eye location, and the set of values is a set of pitch and yaw of the side mirror 102 corresponding to the 3D eye location. Each set of values defines each of a plurality of the corresponding rotation angles for the side mirror 102.

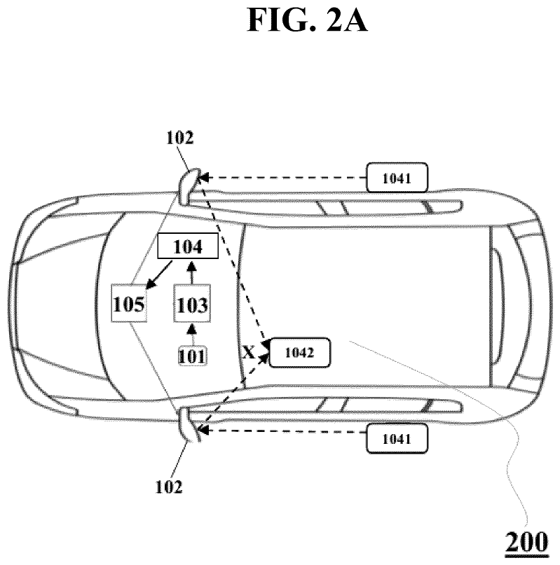

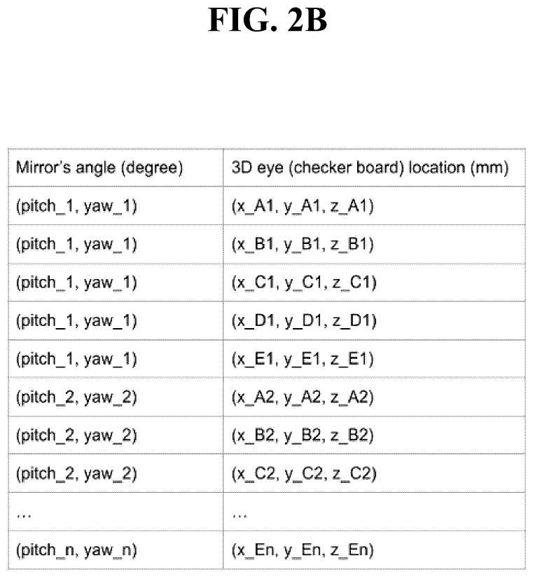

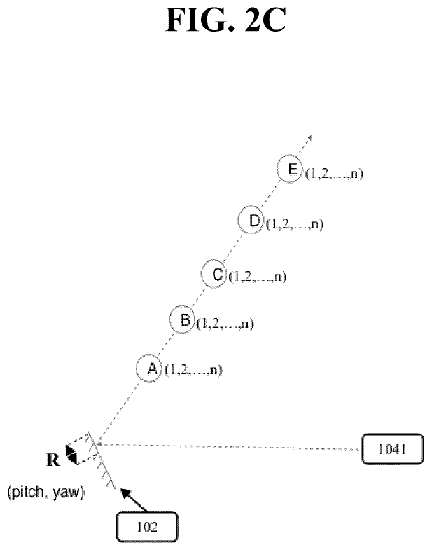

FIG. 2A, FIG. 2B and FIG. 2C depict a sub-system 200 of the system 100 of FIG. 1 for building the lookup table for calculating the optimal rotation angle for the side mirror 102 of the vehicle.

In order to build the lookup table for calculating the optimal rotation angle for the side mirror 102, as illustrated in FIG. 2A, a secondary camera 1041 and a target calibration pattern 1042 is provided. The secondary camera 1041 may be attached to the rear handle of the vehicle and positioned so that the secondary camera 1041 faces the side mirror 102 and is able to capture the target calibration pattern 1042 via the side mirror 102. The target calibration pattern 1042 is placed at the driver's seat of the vehicle for simulating the eye of the driver. The target calibration pattern 1042 may be a checkerboard pattern, for example. The primary camera 101 may capture the target calibration pattern 1042 and map each of a plurality of positions in the pattern, for example, a cell of the checkerboard pattern, to the 3D coordinate of the primary camera 101. As illustrated in FIG. 2A, mark X in the pattern 1042, for example, the top left cell of the checkerboard pattern, may be registered as a driver's eye having a 3D eye location with respect to the 3D coordinate of the primary camera 101, which has the coordinate (xᵢ, yᵢ, zᵢ) corresponding to its location i with respect to the 3D coordinate of the primary camera 101, each coordinate corresponding to the x-axis, y-axis, and z-axis in the 3D coordinate.

Next, the side mirror 102 is moved to a plurality of rotation angles, each angle is defined by a set of values (pitch, yaw). And then, for each set of values, the target calibration pattern 1042 is moved, namely, mark X is moved to at least k positions simulating the driver's movements, such that images of the target calibration pattern, namely, mark X that is captured by the secondary camera 1041 stays within a predetermined region on the side mirror 102.

In particular, the side mirror 102 may be rotated at a rotation angle having a first set of pitch and yaw, this rotation angle may be determined as a first rotation angle having a first set of pitch and yaw (pitch_1, yaw_1) as shown in the table of FIG. 2B, which shows exemplary rows of the built lookup table. In an example, k is set to 5. Accordingly, the target calibration pattern 1042 is then moved to five positions in the vehicle, namely, mark X in the pattern 1042 is moved to five different positions A1, B1, C1, D1, E1, respectively, as illustrated in FIG. 2C, such that the images of the target calibration pattern 1042, namely, mark X, captured by the secondary camera 1041 stays within a predetermined region R on the side mirror 102. According to an embodiment, if dividing the surface of the side mirror 102 into three equal parts according the length of the side mirror, the predetermined region is set to a part of the three equal parts that is nearest to the body of the vehicle. In other examples, k may be set to a value that is less than or greater than 5.

The five positions with respect to the 3D coordinate of the primary camera 101 of the automatic mirror adjustment system are recorded, each of which is determined as a key. In particular, each of these positions A1, B1, C1, D1, and E1 is determined as having a 3D eye location and then recorded with respect to the 3D coordinate of the primary camera 101, as illustrated in FIG. 2C, for example, the coordinate (x_A1, y_A1, z_A1) of position A1, the coordinate (x_B1, y_B1, z_B1) of position B1, the coordinate (x_C1, y_C1, z_C1) of position C1, the coordinate (x_D1, y_D1, z_D1) of position D1, and the coordinate (x_E1, y_E1, z_E1) of position E1, are recorded as keys.

Next, the keys are paired with each set of values to generate the plurality of rows of the lookup table. In particular, each pair of key being the above 3D eye location and set of values being the set of pitch and yaw (pitch_1, yaw_1) is recorded as a row of the lookup table. As such, five rows of the lookup table for each set of values are obtained from the above process.

The same process as the above is performed when the side mirror 102 is rotated to a second position at a second rotation angle having a second set of pitch and yaw (pitch_2, yaw_2), as illustrated in FIG. 2B. Similarly, as shown in FIG. 2C, five different positions A2, B2, C2, D2, and E2, each corresponds to the second set of pitch and yaw (pitch_2, yaw_2), are determined. Each of the positions A2, B2, C2, D2, and E2 has the coordinates (x_A2, y_A2, z_A2), (x_B2, y_B2, z_B2), (x_C2, y_C2, z_C2), (x_D2, y_D2, z_D2), and (x_E2, y_E2, z_E2), respectively, which are recorded and paired with the second set of pitch and yaw (pitch_2, yaw_2) to obtain pairs of keys and sets of value for other five rows of the lookup table.

The same process is repeated for each set of pitch and yaw of the side mirror 102 for n times, in order to obtain, for example, (n×5) rows for the lookup table. In an example, n may be set to 100, and 500 rows of the lookup table are thereby obtained.

Subsequent to the building of the lookup table, the optimal rotation angle for the side mirror 102 is calculated based on the estimated 3D eye location using the lookup table. In particular, based on the estimated eye location, m keys from the rows of the lookup table nearest to the estimated 3D eye location are specified, then the optimal set of pitch and yaw is inferenced, for example, by averaging the values of m sets of pitch and yaw corresponding to the m keys. In an example, m keys nearest to the estimated 3D eye location may be set to 4 or more. As such, the optimal rotation angle of the side mirror 102 is defined by the calculated optimal set of pitch and yaw.

The using the lookup table simplifies the process of calculating the optimal rotation angle for the side mirror 102 compared to other known methods in the prior art since it is not required exact transformation between the mirror and the camera (for example, the side mirror 102 and the primary camera 101 of the system 100 illustrated in FIG. 1) and it can work with all kinds of mirrors other than plane mirrors.

The calculation of the optimal rotation angle of the side mirror 102 may be performed continuously based on the current eye location of the driver in order to obtain the exact optimal rotation angle for the side mirror 102 in real-time.

Referring back to FIG. 1, the system 100 further comprises a mirror control module 105 configured to rotate the side mirror 102 to a target position in accordance with the calculated optimal rotation angle (i.e., the mapped set of pitch and yaw) as described above. The information of the calculated optimal rotation angle may be implemented as a form of control signal which is sent to the mirror control module 105 subsequent to the calculation of the optimal rotation angle using the mapping module 104. The rotation of the side mirror 102 by the mirror control module 105 for adjusting the side mirror 102 to the optimal rotation angle may be performed automatically and/or manually, or both in a sequentially manner. The automatic adjustment process of the side mirror 102 may be activated through a command using a button and/or option in the infotainment system of the vehicle, for example. Alternatively, the side mirror 102 may be adjusted manually using the mirror control module 105 by the driver for fine-tuning. In another example, the automatic adjustment process may be used in conjunction with the manual adjustment of the side mirror 102. For example, the automatic adjustment process may be performed by the system 100, however, the driver may still further manually adjust the side mirror 102 based on their individual preferences.

The system 100 may automatically adjust the side mirror 102 when the driver is in the driver's seat and starts the vehicle, or the automatic adjustments of the side mirror 102 may be performed continuously, periodically and/or at optional intervals set by the system 100 and then selected by the driver via a control panel and/or an interface of the infotainment system of the vehicle, for example.

The mirror control module 105 may be provided with at least one encoder configured to identify the current rotation angle (pitch and yaw) of the side mirror 102 and control the side mirror 102 based on the current rotation angle of the side mirror 102 and the respective mapped set of pitch and yaw in combination.

According to an embodiment of the invention, two encoders (not shown) are provided to the mirror control module 105, each of which is for each rotation axis of the side mirror 102 (i.e., yaw and pitch). As such, compared to other known mirror control modules of the prior art, it is easy to control the side mirror 102 precisely by using any control algorithm (e.g., PID) implemented in the two encoders provided with the mirror control module 105 of the system 100.

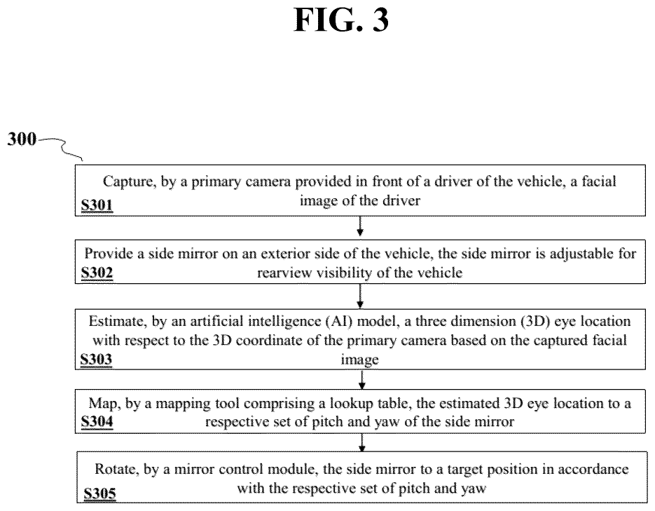

FIG. 3 is a flow chart depicting an automatic mirror adjustment method 300 (hereinafter referred to as method 300) for a vehicle according to an embodiment of the invention. For convenience, the method 300 will be described as being performed by a system, for example, the automatic mirror adjustment system 100 of FIG. 1 (hereinafter referred to as the system).

In step S301, the system captures a facial image of the driver by a primary camera provided in front of a driver of the vehicle. The primary camera, for example, the primary camera 101 of the system 100 in FIG. 1, may be pre-installed in the vehicle at the time of manufacturing, or may be a third-party camera that may be installed later in the vehicle and integrated with the system. According to an embodiment, the primary camera is selected from an infrared camera and a RGB camera.

In step S302, the system provides a side mirror (for example, the side mirror 102 of FIG. 1) on an exterior side of the vehicle, the side mirror is adjustable for rearview visibility of the vehicle.

In step S303, the system estimates, using an artificial intelligence (AI) model (for example, the AI model 103 of FIG. 1), a three dimension (3D) eye location with respect to the 3D coordinate of the primary camera based on the captured facial image. According to an embodiment, the AI model estimates the 3D eye location by predicting at least 46 facial landmarks on an image plane and solving a Perspective-n-Point (PNP) problem to find a transformation matrix from the head of the driver to the primary camera.

In step S304, the system maps, using a mapping module (for example, the mapping module 104 of FIG. 1) comprising a lookup table, the estimated 3D eye location to a respective set of pitch and yaw of the side mirror, wherein the lookup table comprises a plurality of rows, each row contains a pair of a key and a set of values, and wherein the key is a 3D eye location and the set of values is a set of pitch and yaw of the side mirror corresponding to the 3D eye location.

According to an embodiment, step S304 comprises specifying m keys in the lookup table nearest to the estimated 3D eye location, and inferencing the respective set of pitch and yaw based on m sets of values corresponding to said m keys. In an example, m is set to 4 or more.

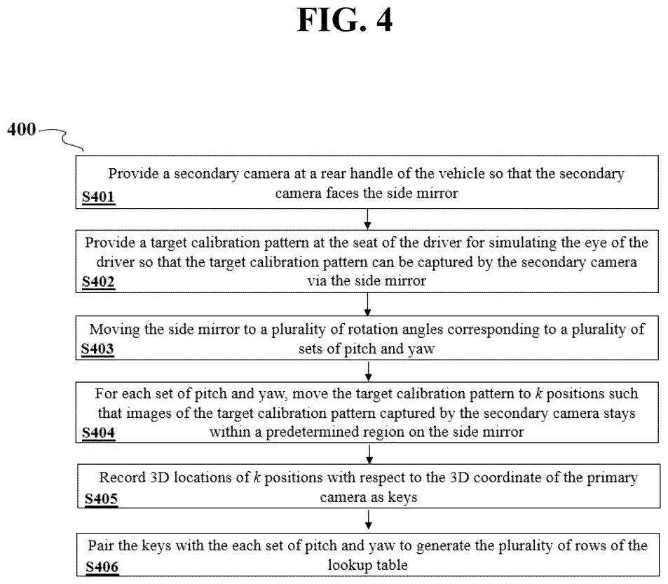

FIG. 4 illustrates a process of building the lookup table used in the automatic mirror adjustment method 300 (hereinafter referred to as process 400). For convenience, the process 400 will be described as being performed by a sub-system of the automatic mirror adjustment system of FIG. 1, for example, the sub-system 200 of FIG. 2 (hereinafter referred to as the sub-system).

In step S401, the sub-system provides a secondary camera (for example, the secondary camera 1401 of FIG. 2) at a rear handle of the vehicle so that the secondary camera faces the side mirror.

In step S402 the sub-system provides a target calibration pattern (for example, the target calibration pattern 1402 of FIG. 2) at the seat of the driver for simulating the eye of the driver so that the target calibration pattern can be captured by the secondary camera via the side mirror.

In step S403, the sub-system moves the side mirror to a plurality of rotation angles corresponding to a plurality sets of pitch and yaw.

In step S404, the sub-system moves the target calibration pattern to k positions such that images of the target calibration pattern captured by the secondary camera stays within a predetermined region on the side mirror for each set of pitch and yaw.

According to an embodiment, if dividing the surface of the side mirror into three equal parts according the length of the side mirror, the predetermined region is set to a part of the three equal parts that is nearest to the body of the vehicle.

In step S405, the sub-system records 3D locations of the plurality of positions with respect to the 3D coordinate of the primary camera as keys.

In step S406, the sub-system pairs the keys with the each set of pitch and yaw to generate the plurality of rows of the lookup table.

According to an embodiment, k is set to 5 or more and the lookup table comprises 500 rows or more.

Referring back to FIG. 3, in step S305, the system rotates, using a mirror control module (for example, the mirror control module 105 of FIG. 1), the side mirror to a target position in accordance with the respective set of pitch and yaw.

According to an embodiment, the mirror control module comprises at least one encoder configured to identify the current set of pitch and yaw of the side mirror and control the side mirror based on the identified current set of pitch and yaw and the respective mapped set of pitch and yaw in combination.

According to another embodiment, the mirror control module comprises two encoders, one encoder of the two encoders is used for a pitch axis and another encoder is used for a yaw axis.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for adjusting a side mirror of a vehicle, the method comprising:
capturing, by a primary camera provided in front of a driver of the vehicle, a facial image of the driver;
estimating a three dimensional (3D) eye location with respect to a 3D coordinate of the primary camera based on the captured facial image;
mapping the estimated 3D eye location to a respective set of pitch and yaw of the side mirror based on a lookup table, wherein the lookup table comprises a plurality of rows, each row containing a pair of a key and a set of values, and wherein the key is a 3D eye location and the set of values includes a set of pitch and yaw of the side mirror corresponding to the 3D eye location; and
rotating the side mirror to a target position in accordance with the respective set of pitch and yaw;
wherein the method further comprises building the lookup table, comprising:
providing a secondary camera at a rear handle of the vehicle, the secondary camera configured to face the side mirror;
providing a target calibration pattern at a driver seat for simulating an eye of the driver to allow the target calibration pattern to be reflected by the side mirror and captured by the secondary camera;
moving the side mirror to a plurality of rotation angles corresponding to a plurality of sets of pitch and yaw;
for each set of pitch and yaw, moving the target calibration pattern to k positions to allow images of the target calibration pattern captured by the secondary camera to be within a predetermined region on the side mirror;
recording 3D locations of k positions with respect to the 3D coordinate of the primary camera as keys; and
pairing the keys with the each set of pitch and yaw to generate the plurality of rows of the lookup table.

2. The method of claim 1, wherein the mapping comprises specifying m keys in the lookup table nearest to the estimated 3D eye location, and inferencing the respective set of pitch and yaw based on m sets of values corresponding to said m keys.

3. The method of claim 2, wherein the mirror control module comprises at least one encoder configured to identify the current set of pitch and yaw of the side mirror and control the side mirror based on the identified current set of pitch and yaw and the respective set of pitch and yaw in combination.

4. The method of claim 3, wherein the AI model estimates the 3D eye location by predicting at least 46 facial landmarks on an image plane and solving a Perspective-n-Point (PNP) problem to find a transformation matrix from the head of the driver to the primary camera.

5. The method of claim 4, wherein k is set to 5 or more and m is set to 4 or more.

6. The method of claim 5, wherein the lookup table comprises 500 rows or more.

7. The method of claim 6, wherein the mirror control module comprises two encoders, one encoder of the two encoders being used for a pitch axis and another encoder being used for a yaw axis.

8. The method of claim 7, wherein dividing the surface of the side mirror into three equal parts based on a length of the side mirror, and the predetermined region is set to a part of the three equal parts that is nearest to a body of the vehicle.

9. The method of claim 1, wherein the primary camera is an infrared camera or an RGB camera.
